(19) United States
(12) Patent Application Publication
(10) Pub. No.: US 2022/0299307 A1
(43) Pub. Date: Sep. 22, 2022

(54) DRAW WIRE SENSOR

(71) Applicant: Dana Motion Systems Italia S.R.L., Reggio Emilia (IT)

(72) Inventor: Enzo Zanichelli, Reggio Emilia (IT)

(21) Appl. No.: 17/654,967

(22) Filed: Mar. 15, 2022

(30) Foreign Application Priority Data
Mar. 16, 2021 (DE) 20 2021 101 325.7

(51) Int. Cl. G01B 7/30; G01D 5/16

(52) U.S. Cl. CPC G01B 7/30; G01D 5/16; B66C 13/46

(57) ABSTRACT

A draw wire sensor which measures distance. The draw wire sensor comprising: a reel, shaft or axle; a wire wound up on the reel, shaft or axle; and a rotational sensor coupled to the reel, shaft or axle. A rotation angle of the sensor is transformed into an electrical signal and the rotational sensor utilizes the tunnel magnetoresistance effect.

### CROSS-REFERENCE TO RELATED APPLICATION

The present application claims priority to German Utility Model Application No. 20 2021 101 325.7, entitled “DRAW WIRE SENSOR”, and filed on Mar. 16, 2021. The entire contents of the above-listed application is hereby incorporated by reference for all purposes.

### TECHNICAL FIELD

The present disclosure relates primarily to draw wire sensors. Draw wire sensors are typically used for measuring linear distances, mainly for keeping track of the linear movement of objects. A draw wire sensor usually comprises a wire or measuring wire that is wound up or configured to be wound up on a reel, shaft or axle. An extension of the draw wire then corresponds with a rotation of the spool, shaft or axle. In the prior art, the spool or axle is normally coupled to a potentiometer which allows measuring electrical signals indicative of a rotation angle of the potentiometer and of the extension of the wire. Draw wire sensors are usually applied in industrial environments or in environments that require high precision and reliability.

### BACKGROUND AND SUMMARY

However, electrical potentiometers are typically costly and may be difficult to manufacture. Often, their measurement precision and reliability deteriorate over time. For applications in off-highway vehicles and machinery and in other rough environments, less expensive and more reliable solutions may be sought.

Therefore, it is a goal of the presently proposed innovation to design a draw wire sensor with improved reliability and robustness which may be less expensive than traditional sensors.

This goal is solved by embodiments discussed in this application.

The presently proposed draw wire sensor for measuring linear distances comprises:
a reel, shaft or axle,
a wire or measuring wire wound up or configured to be wound up on the reel, shaft or axle, and
a rotational sensor coupled to the reel, shaft or axle and configured to transform a rotation angle of the sensor into an electrical signal or, in other words, configured to produce an electrical signal indicative of a rotation angle of the rotational sensor, wherein the rotational sensor is based on or configured to operate based on the tunnel magnetoresistance effect.

Magnetoresistive sensors based on or configured to operate based on the tunnel magnetoresistance (TMR) effect are becoming more and more attractive and available for a variety of purposes. As they provide high signal amplitude, they can be combined with microcontrollers without additional circuitry and in many cases no preamplifiers are necessary. Usually, these sensors can easily be realized with high impedance and need only very little space. Therefore, TMR sensors are typically suitable for battery powered applications. They normally provide long term stability and reproducibility of measurements. They usually also offer a high degree of absolute accuracy. Rotational sensors on the basis of the tunnel magnetoresistance effect with an analogue electrical signal output can be realized by a tunnel magnetoresistive element and a magnet wherein one of these two elements is configured to rotate relative to the other, and the electrical resistance of the magnetoresistive element is measured.

The rotational sensor may comprise a stationary part or stationary portion including a tunnel magnetoresistance element, and a rotating part or rotating portion including a magnet.

The stationary part may comprise a magnetic reference layer with a fixed magnetization direction, and a magnetic sensing layer. The magnetization of the sensing layer usually follows the external field which may be imposed by an external, rotatable magnet which may form part of the rotating part of the sensor. A thin isolating barrier between the reference and the sensing layer typically includes a metal oxide like MgO and may be thin enough for electrons to pass through the isolating barrier by tunneling. Normally, the electrical resistance of such a tunnel junction strongly depends on the angle between the magnetization directions of the reference layer and of the sensing layer. Therefore, the electrical resistance corresponds with or is indicative of the rotation angle of the external rotatable magnet relative to the stationary part of the sensor.

The thickness and area of the isolating barrier may be chosen according to the specific application. For example, the electrical resistance of the isolating barrier may range from Ohms to MOhms. Hence, sensors with low power consumption may be realized. The size of the magnetoresistive elements is usually in the order of micrometers. Consequently, such sensors may require only limited space. Wear during longer operational times is usually negligible, because as opposed to traditional potentiometers there is typically no friction or almost no friction between the parts which move relative to each other. Further, temperature sensitivity is typically low, which may be a further advantage over traditional potentiometers.

The rotating part of the rotational sensor may be coupled to the reel, shaft or axle by means of a gear. This way, it can be made sure that the full measurable extension, that is the maximal distance the sensor is configured to measure, corresponds to a desired or predetermined fraction of a full rotation, i. e. of a rotation by 360 degrees. Also, by choosing the appropriate translation or gear ratio provided by the gear, the desired resolution of the measurement can be realized.

For example, the total measurable distance and an extension of the wire corresponding with the total measurable distance may correspond to a rotation of the rotating part of the rotational sensor by 360 degrees or less. In special cases, the total measurable distance may also correspond to a rotation by less than 360 degrees, for example, by less than 270 degrees or by less than 180 degrees.

The rotational sensor may comprise a spring configured to maintain the tension of the wire. For this purpose, the draw wire sensor may comprise a spring such as a spiral spring that is coupled to the rotatable part of the sensor and biases the reel, shaft or axle to rotate in a direction in which it winds up the draw wire. This way, the tension of the draw wire may be maintained constantly.

The stationary part of the rotational sensor may be mounted on a printed circuit board. Typically, the rotational sensor is electrically coupled with or to a measurement unit for measuring the electrical resistance of the magnetoresistance element. For instance, the stationary part of the sensor may be directly coupled with or to the measurement unit.

Consequently, the measurement unit for measuring the electrical resistance of the magnetoresistive element can typically be easily contacted via conductors on the printed circuit board with the magnetoresistive element and all electric connections may be realized as printed or etched conductors on a printed circuit board. This way, all electric contacts that are involved in measuring the resistance are usually reliable and stable. The printed circuit board (PCB) may include all electric circuitry required for a sensitive resistance measurement.

Further, the measurement unit may in some cases comprise a measurement bridge, for example a Wheatstone bridge. By using this measurement technology, a differential resistance measurement may be carried out with high accuracy and reproducibility. The functionality of a Wheatstone bridge is well known and will therefore not be further explained in detail.

The draw wire sensor may further comprise an electric power supply for powering the rotational sensor. The electric power supply may include a battery, for example.

As the magnetoresistive element and for instance its isolating metal oxide barrier may be realized with a high electrical resistance in the range of many KOhms or MOhms, electric power consumption for continuous measurements of the electrical resistance is typically low and the measurement unit may be powered by a small battery, or at least an emergency power supply may easily be provided by a battery.

It is conceivable that the presently proposed draw wire sensor comprises a further rotational TMR sensor of the above-described type. In this case, the two rotational TMR sensors may be coupled to the reel, shaft or axle in parallel in order to create a redundant measuring system.

The presently proposed innovation is not restricted to a draw wire sensor as described above, but may also be directed to a mobile machine, such as a vehicle or a crane including a draw wire sensor as described above. Machinery that must work reliably also in rough, off-road applications, may benefit from the use of draw wire sensors that work on the basis of tunnel magnetoresistance sensors.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

Embodiments of the presently proposed draw wire sensor and of the presently proposed mobile machine are described in the following detailed description and are depicted in the figures. FIGS. 1-5 are shown approximately to scale.

### BRIEF DESCRIPTION OF THE FIGURES

FIG. 1 schematically shows a magnetoresisitve sensor and its operating principle.

FIG. 2 schematically shows a 3d view of a magnetoresistive sensor coupled to a spool on which the draw wire is wound up.

FIG. 3 schematically shows a housing with a sensor on a PCB.

FIG. 4 schematically shows a vehicle with a potential application for a draw wire sensor.

FIG. 5 schematically shows another view of the vehicle with a potential application for a draw wire sensor.

### DETAILED DESCRIPTION

FIG. 1 schematically shows the structure of a magnetoresistive sensor 3. The sensor 3 comprises a stationary part or stationary portion 3a. Here, the stationary part 3a is fixed to a printed circuit board or PCB 6. The stationary part 3a comprises a magnetoresistive element 3b including a reference element 9a, a sensing element 9b and an isolating barrier 9c disposed in between the reference element 9a and the sensing element 9b. The reference element 9a and the sensing element 9b may be one or more of magnetic, ferromagnetic, or iron. The electrical resistance of the isolating barrier 9c strongly depends on the alignment of magnetic field directions of the reference element 9a and of the sensing element 9b. The magnetic field direction of the sensing element 9b is influenced by the magnetic field direction of an external rotatable magnet 3d. Hence, the electrical resistance of the sensor 3 reflects or is indicative of a rotation angle of the rotatable magnet 3d. Thus, the rotation angle of the rotatable magnet 3d may be measured by measuring the electrical resistance of the sensor 3.

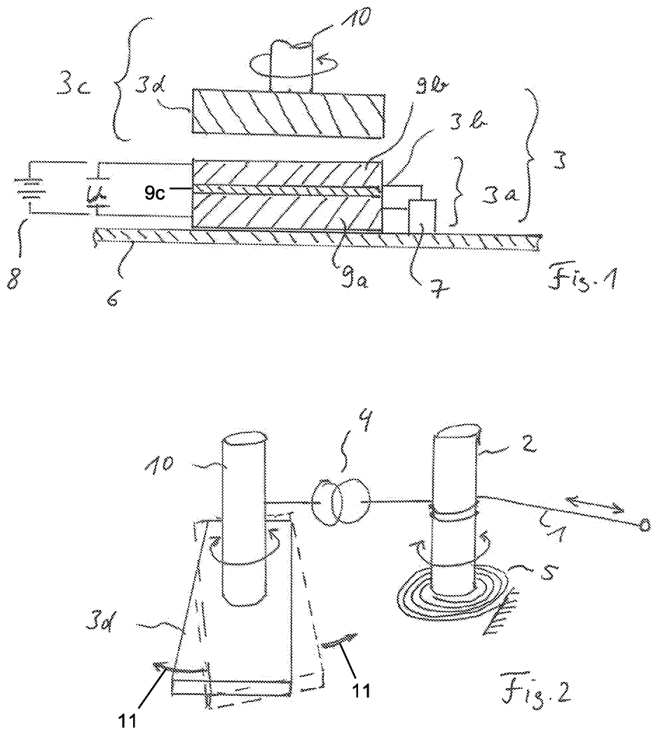

As can be seen in FIG. 2, the rotatable magnet 3d is fixed to a shaft 10 that is coupled to a reel, shaft or axle 2. Here and in all of the following, recurring features shown in different figures are designated with the same reference signs. A draw wire 1 is wound up on the shaft/axle 2 and any extension of the draw wire 1 may be measured by a change of the electrical resistance of the magnetoresistance sensor 3. The shaft 2 is mechanically coupled to the shaft 10 by means of a gear 4 which is only represented symbolically in FIG. 2 and not shown in detail. The gear 4 may comprise a plurality of gearwheels, for example.

It is understood that in alternative embodiments not depicted here, a portion of the rotational sensor 3 may be directly mounted on or fixed to the shaft or axle 2. For example, in such an alternative embodiment either one of the magnet 3d or the magnetorisistive element 3b may be mounted on or fixed to the shaft or axle 2.

Returning to the embodiment depicted in the figures, a spiral spring 5 is provided which maintains a torque on the shaft 2. In this way, the spiral spring 5 maintains a longitudinal tension on the draw wire 1. In FIG. 2, the rotatable magnet 3d is shown in bold in a first position and as a dotted line in a second position, wherein the second position is rotated about the rotational axis of the shaft 10 by a few degrees with respect to the first position. The arrows 11 show the directions of movement of the draw wire 1 in case the draw wire 1 is extended or drawn back by the spiral spring 5.

FIG. 3 shows a housing 12 of a draw wire sensor with a printed circuit board 6, a shaft 2 on which the draw wire 1 is or may be wound, and a shaft 10 which forms part of the rotating part 3c of the sensor. The rotating part or rotating portion 3c of the sensor is positioned below the printed circuit board in FIG. 3. The stationary part 3a, a measurement unit 7 (see FIG. 1) and possibly further circuitry configured to carry out the resistance measurement are positioned on the printed circuit board 6.

Optionally, the draw wire sensor may include a second TMR sensor which is or may be mechanically coupled to the shaft 2 in order to create a redundant measuring system.

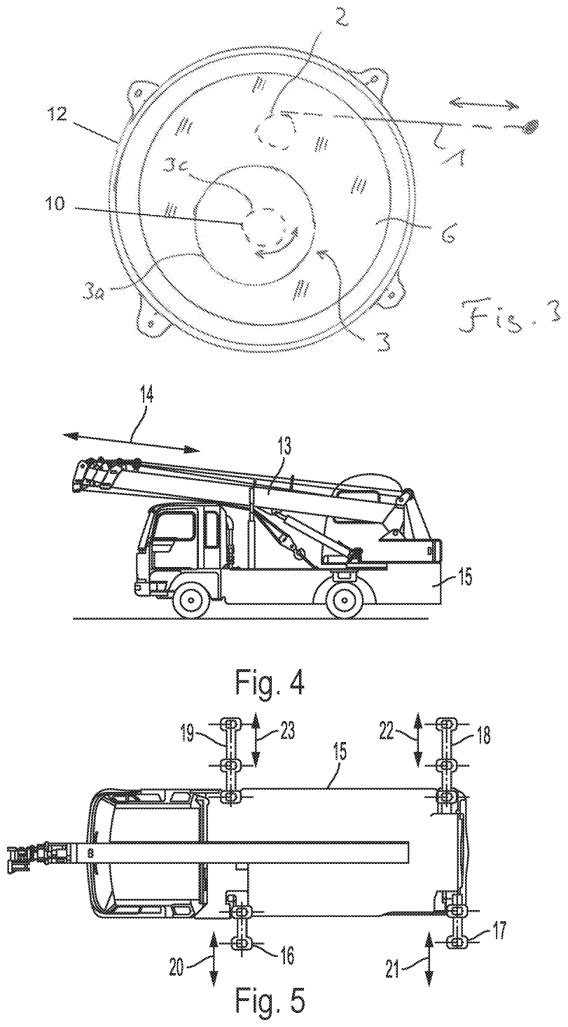

FIG. 4 shows a truck 15 with an extendable boom 13. The bidirectional arrow 14 shows the directions in which a draw wire sensor may measure linear movements while the boom is extended or retracted.

FIG. 5 shows the truck 15 in a top view with extendable support arms 16, 17, 18, 19 for stabilization of the truck, for example during stationary operation of the truck 15. The single support arms are extendable a certain distance which may be measurable by a draw wire sensor of the presently proposed type in the directions indicated by double arrows 20, 21, 22, 23.

FIGS. 1-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A draw wire sensor for measuring linear distances, comprising:
a reel, shaft or axle,
a wire wound up on the reel, shaft or axle, and
a rotational sensor coupled to the reel, shaft or axle, a rotation angle of the sensor is transformed into an electrical signal, and the rotational sensor utilizes the tunnel magnetoresistance effect.

2. The draw wire sensor of claim 1, wherein the rotational sensor comprises a stationary part including a tunnel magnetoresistance element and a rotating part including a magnet.

3. The draw wire sensor of claim 1, wherein a rotating part of the rotational sensor is coupled to the reel, shaft or axle.

4. The draw wire sensor of claim 1, wherein a total measurable distance and an extension of the wire corresponding with the total measurable distance correspond to a rotation of the rotating part of the rotational sensor by 360 degrees or less.

5. The draw wire sensor of claim 1, wherein the rotational sensor comprises a spring configured to maintain a tension of the wire.

6. The draw wire sensor of claims 2, wherein the stationary part of the rotational sensor is mounted on a printed circuit board.

7. The draw wire sensor of claims 2, wherein the rotational sensor is electrically coupled with a measurement unit for measuring the electrical resistance of the magnetoresistance element.

8. The draw wire sensor of claim 7, wherein the measurement unit comprises a Wheatstone bridge.

9. The draw wire sensor of claims 1, further comprising an electric power supply including a battery electrically connected or electrically connectable with the rotational sensor.

10. A mobile machine, including the draw wire sensor according to claim 1.

11. A sensor comprising:
a rotating component; and
a rotational sensor coupled to the rotating component, the rotational sensor comprising:
a tunnel magnetoresistance element, and
a rotating magnet.

12. The sensor of claim 11, wherein a rotation angle of the rotating magnet changes a resistance of the tunnel magnetoresistance element and the resistance of the tunnel magnetoresistance element is converted to an electrical signal.

13. The sensor of claim 12, wherein the tunnel magnetoresistance element comprises a reference element, a sensing element, and an isolating barrier positioned between the reference element and sensing element.

14. The sensor of claim 13, wherein the reference element is mounted to a circuit board and the rotating magnet rotates adjacent to a side of the sensing element opposite the circuit board.

15. The sensor of claim 13, wherein the rotation angle of the rotating magnet changes a magnetic field direction of the sensing element and the magnetic field direction of the sensing element changes a resistance of the isolating barrier.

16. The sensor of claim 13, wherein the reference element and the sensing element are magnetic and the isolating barrier comprises a metal oxide.

17. The sensor of claim 11, wherein a gear couples the rotating component and the rotational sensor such that the rotating component and the rotational sensor rotate at different speeds.
